(19) United States
(12) Patent Application Publication
(10) Pub. No.: US 2011/0313877 A1
(43) Pub. Date: Dec. 22, 2011

(54) Method of Conducting Limited Time Offers for Non-Identical Items and Personal and Professional Services over the Internet

(76) Inventor: James Pruett, Houston, TX (US)

(21) Appl. No.: 12/820,283

(22) Filed: Jun. 22, 2010

(51) Int. Cl. G06Q 30/00

(52) U.S. Cl. 705/26.2

(57) ABSTRACT

A system for aggregating demand through an online buying group, which may include: (a) an e-commerce server-data processing system and configured to define a buying marketplace for a featured at least two different items by specifying the featured at least two different items for the marketplace, a time interval during which the marketplace is available, the marketplace defining a predetermined partial number of different items to activate the sale and one or more prices for the featured product available through the marketplace, (b) a buyer client data processing system coupled to said e-commerce server-data processing system, to display the data describing the conditions for the featured items on the buyer client data processing system, and to receive buyer order inputs that include the buyer's offer for the featured items and to transmit the buyer order inputs for the featured items to said e-commerce server-data processing system.

### FIELD OF THE INVENTION

The present invention relates to demand aggregation for goods and services and the computerized operation of global buying individuals or groups being conducted over electronic networks such as the Internet.

### BACKGROUND

The vast majority of retail methods of commerce do not permit any give and take between buyer and seller regarding terms of purchase. Instead, they generally employ a seller-controlled format whereby the seller determines which items (products and services) are to be offered for sale, when each item will be offered for sale, and the non-negotiable fixed price at which each item will be sold. Traditional stores (including most online stores), catalog sales, telemarketing sales, and classified ads all represent examples of this prevalent seller-controlled sales environment.

While the auction sales format permits buyer interaction, it too vests most of the bargaining power in the seller by permitting him or her to select the item to be sold and the time at which it will be offered for sale. Auctions also typically permit the seller to specify a minimum price at which the item may be sold. Moreover, the auction model further deteriorates the power of each individual buyer by pitting him or her against similarly situated buyers, all competing to pay the highest price for the item.

Historically, individual buyers have sought to achieve collective buying power, among other things, by joining a traditional, true “co-op”—i.e., an organization that is actually owned by and operated for the benefit of those using its services. Such organizations usually are comprised of individual members with common business, occupational, or recreational interests. Members of these co-ops pay annual membership fees (typically sufficient to cover the operating costs of the co-op entity) for the privileges of membership, which often include access to information, products and services related to the co-op's defined purpose.

Traditional buying co-ops (including those emerging on the Internet) have been organized around a common set of interests much broader than a particular product (e.g., a digital camera), or even a narrowly defined product category (e.g., cameras). As a result, the extent to which they can aggregate demand for any given product or service is limited by the organization's defined membership base and topical focus. Historically, this breadth of member commonality was required. Otherwise, the benefits achieved through the co-op would be vastly outweighed by the amount of time, money and energy expended to join and maintain the membership.

At the time of this invention, buying groups organized globally on a purchase by purchase basis do not exist. In addition, there is no single mechanism though which people can quickly and conveniently create or join any special interest group of their choosing for purchasing products through a global electronic network such as the Internet.

A method for presenting a pledge has been previously introduced. At this time, there is just a single method of presenting a threshold pledge that is used by group buying or crowd sourcing Web sites popularized in 2009 by Groupon, Inc. This simple method is to create volume discounts for a single item or a single product offer, such as discounts on a restaurant, an event, or a service provider. But, this method is ineffective when offering products in bulk that are characterized by essential differences or even marginal differences, such as typically found in homes or automobiles. With a home or automobile, it is unlikely to find two that have identical features and, as a consequence, would demand an identical price. It is fairly safe to say that no two houses or automobiles are exactly identical. These types of items (products and services) will have differences; for example different wear experiences that will affect the price. These types of items (products and services) may originally be produced and sold by the same manufacturer, yet these types of items (products and services) are merely similar and not identical. Buyers will uniformly desire a particular housing unit or auto over another, requiring the offer to be designed as an offer on an individual item, defying easy adaptability to the standard, simple method of a conducting a threshold pledge.

Additionally, since every condo project or housing subdivision has individual units that are less desirable than others, should the seller require a total sellout of the offer a single home may represent a serious obstacle to reaching the minimum threshold needed to make to the entire offer successful. While it remains possible to offer housing or autos in a bulk buy as a group, since these items offered are not identical, many buyers will favor on item over another, creating disappointment and potential for rejection from buyers that are unable to secure the item of their preference.

Businesses that provide local services such as restaurants, spas, fitness studios, real estate brokerage, and cosmetics are just a few examples of organizations that have diverse offerings. Reducing the offerings of such business into a single offer is not consistent with the menu of options available to persons when they deal directly with the business provider. Any business that has more than one product or service offering would benefit from the ability to present multiple offers simultaneously within the context of a single limited offer and or single threshold pledge. In addition to this, businesses and consumers will benefit from the personalization and customization of limited time offers beyond a single item or service.

U.S. Pat. No. 6,631,356 discloses an online buying group (referred to herein as a “co-op”) is formed for the specific purpose of purchasing a particular product by defining a start time, end time, critical mass, any minimum number of units offered, any maximum number of units offered, starting price, and product cost curve. As data is gathered from buyers by means of their making binding purchase offers, the co-op is modified using a pricing tool, so as to take into account for this market data in the definition of the price curve. A buyer chooses a product co-op of interest. The buyer is presented with the following essential co-op information: current price, closing time, and next price level (as defined by a price-curve visibility window and the price curve) sufficient to entice the buyer to make an offer. Once a buyer has made up his mind, the decision must be made to offer a purchase price which includes the current price, guaranteeing availability if critical mass has been achieved, or to make an offer at a lower price range that can be accepted only if the co-op price drops to that level, which may not occur. Given a decision to make an offer at such lower price, the buyer enters such maximum price at which he is willing to purchase the product. Should the current price drop to the level at which the offer was made, the price contingency is removed from such offer and assuming critical mass is achieved, the offer is accepted at the close of the co-op, and processed accordingly. Inventory is allocated to fulfill the accepted offer following the closing of the co-op. This patent does not take into consideration the differences that can occur from product to product.

US patent application 2008/0077535 discloses a system and method for facilitating media creation that includes a marketplace module and facilitator that enable an artist to create a work or media and then distribute the work or media to the public, or a segment thereof. The marketplace module provides avenues for free speech, commentary, and constructive criticism; for example, of an artist's idea or work in order to encourage the creation of media which appeals to a minimum threshold of the public. The facilitator aggregates funds to satisfy an artist's commission by enabling negotiations between one or more members of the public and the artist. This patent application does not take into consideration the differences that can occur from product to product.

US patent application 2006/0167765 discloses a method for generating a page for charitable fund raising over a network. A user creates a definition for a fund raising event and transfers the definition to a fund raising server, which generates event information (e.g., an event record). The user selects a non-profit organization and transfers the selection to the fund raising server, which generates organization information (e.g., organization record). The fund raising server generates a mapping (e.g., mapping record) of the event information to the organization information. The fund raising server creates a fund raising page accessible over the network based on input from the user and providing a link from the fund raising page to the mapping. The user is also able to nominate a non-profit organization which is not yet available for selection, which is then vetted by the fund raising server. This patent application does not take into consideration the differences that can occur from product to product.

FIG. 1 illustrates a display interface 100 to edit and publish a traditional limited time, single offer.

FIG. 2 illustrates an Image and Graphic display 200 of a single item, limited time offer with a Threshold requirement (minimum number of buyers to agree for the offer to be valid) of one.

FIG. 3 illustrates the embodiment of the display interface 300 to edit and publish multiple items (products and services) within a single offer. Information asymmetries result in the confusion of one service or offer with another. Individual discounts are not clearly specified on the daily deal at the display interface 300 may not allow for this feature.

### SUMMARY

A system for aggregating demand through an online buying group, which may include: (a) an e-commerce server-data processing system, said e-commerce server-data processing system including e-commerce server software executable on said e-commerce server-data processing system and configured to define a buying marketplace for at least two different featured items, a time interval during which the marketplace is available, any minimum or maximum quantities of the featured at least two different items available through the marketplace, the marketplace defining a predetermined partial number of different items to activate the sale and one or more prices for the featured product available through the marketplace, said e-commerce server software further being configured to receive offers from buyers and to take orders for the featured items and said e-commerce server software also configured to notify a buyer who has made an successful offer that the offer has been accepted (b) a buyer client data processing system coupled to said e-commerce server-data processing system, said buyer client data processing system including first client software executable on said buyer client data processing system and configured to receive data from said e-commerce data processing system describing the conditions for buying the featured items, to display the data describing the conditions for the featured items on the buyer client data processing system, and to receive buyer order inputs that include the buyer's offer for the featured items and to transmit the buyer order inputs for the featured items to said e-commerce server-data processing system.

The e-commerce server-data processing system may be configured to receive inputs for defining a buying marketplace for the featured items.

The e-commerce server-data processing system may include a pricing tool to establish a price for each of the featured items in the marketplace.

The system may be configured by including data entry tools to establish a start time and an end time for the marketplace.

The e-commerce server-data processing system may be further configured by including data entry tools to establish minimum or maximum quantities. The e-commerce server-data processing system may be configured to receive a buyer order input in terms of an irrevocable, non-cancelable offer to purchase the featured items.

The e-commerce software may be further configured to accept the irrevocable, non-cancelable offer.

The e-commerce server-data processing system may be further configured to receive credit card numbers from buyers to guarantee received purchase offers that may or may not be cancelled prior to the predetermined threshold being met

The e-commerce server software may be further configured to close the buyer marketplace when either the time interval for the co-op has expired, or the maximum quantity of the featured product has been allocated to irrevocable purchase offers.

The e-commerce server-data processing system may be further configured by including data entry tools to calculate a final sales price for the featured product based on acceptable offers received and the quantity of the featured product that has been committed.

The e-commerce server-data processing system may be further configured by including data entry tools to provide order fulfillment instructions for offers that have been accepted.

A system for aggregating demand through an online buying group, which may include: (a) an e-commerce server-data processing system, said e-commerce server-data processing system including e-commerce server software executable on said e-commerce server-data processing system and configured to define a buying marketplace for a featured at least two different products by specifying the at least two different featured items for the marketplace, a time interval during which the marketplace is available, any minimum or maximum quantities of the featured at least two different product available through the marketplace, the marketplace defining a predetermined partial number of different items, a predetermined threshold value number of the predetermined partial number of different items to activate the sale and one or more prices for the featured product available through the marketplace, said e-commerce server software further being configured to receive offers from buyers and to take orders for the featured items and said e-commerce server software also configured to notify a buyer who has made an successful offer that the offer has been accepted (b) a buyer client data processing system coupled to said e-commerce server-data processing system, said buyer client data processing system including first client software executable on said buyer client data processing system and configured to receive data from said e-commerce data processing system describing the conditions for buying the featured product, to display the data describing the conditions for the featured items on the buyer client data processing system, and to receive buyer order inputs that include the buyer's offer for the featured product and to transmit the buyer order inputs for the featured product to said e-commerce server-data processing system.

### BRIEF DESCRIPTION OF THE DRAWINGS

The invention may be understood by reference to the following description taken in conjunction with the accompanying drawings, in which, like reference numerals identify like elements and in which:

FIG. 1: Illustrates the embodiment of the interface to edit and publish a traditional limited time, single offer.

FIG. 2: Illustrates an image and graphic display of a single item, limited time offer with a Threshold requirement (minimum number of buyers to agree for the offer to be valid) of one.

FIG. 3: Illustrates the embodiment of the interface to edit and publish multiple items (products and services) within a single offer. Information asymmetries result in the confusion of one service or offer with another. Individual discounts are not clearly specified on the daily deal at the interface does not allow for this feature.

FIG. 4: Illustrates the embodiment of the interface of first entry page setup for “deals with individual items (products and services)”. System described here utilizes Threshold Pledge requirements as determined by the minimum number which may be one (1) or more. “Original Price” and “Items (products and services) Available” input boxes are blocked here so that they may be described at the individual item interface page. A box described as “Has individual items (products and services)” is made available to “check” to trigger the ability to set up the interface for “Individual items (products and services).”

FIG. 5: Illustrates the embodiment of the interface to present multiple items (products and services) that are to be presented as separate or individual offers. This system has the ability to present individual images to correspond to individual offers.

FIG. 6: Illustrates the embodiment of the interface to set specific discounts that pertain to an individual item. This system has the ability to describe and display a minimum number of items (products and services) that need to be agreed to buy in order to be valid (threshold pledge) and maximum number of available items (products and services) (limited quantity sell out).

FIG. 7: Illustrates an Image and Graphic User Interface to demonstrate the ability of our system to collect a deposit from customer and to reduce amount required by the customer to pay in advance of the deal. Text description shown to describe the ability for show the customer how much is left to pay at the point of purchase.

FIG. 8: Illustrates an Image and Graphic User Interface to describe the ability to display individual items (products and services) as a group of offers via a pop-up window. Image and GUI describe and display an individual discount that corresponds to an individual offer. The example shown is movie theater showings.

FIG. 9: Illustrates the embodiment of the Graphic User Interface that allows our system to display any type of product or service and demonstrate the universal characteristics of this system and method.

FIG. 10: Illustrates the embodiment of the Graphic User Interface that demonstrates the ability to display detailed information for individual item profiles and the ability to easily scroll to view other individual items (products and services) presented under the same limited time deal.

FIG. 11: Illustrates the embodiment of the Graphic User Interface that demonstrates the ability of our system and method to present the discount of individual offers as a range.

FIG. 12: Illustrates the embodiment of the Graphic User interface to display our method and system of presenting individual service providers within a single offer.

FIG. 13: Illustrates the embodiment of the interface that creates the ability to display the required minimum number for the offer to be valid. Our system and method allows that the minimum may be a fraction of the entirety. For example, 5 of 6 offers are required for the offer to be valid as described in FIG. 13. System and method allows for the ability to personalize the offer by featuring individual service providers: Alex, Mandy, Carlton, D'Ondra, Karolyn, or Jose. System and method allows for the ability to redeem at multiple locations, which may be individualized to the individual service provider.

FIG. 14: Illustrates the embodiment of the interface to set and display maximum number items (products and services) of available (sell out). Each individual provider may set their own requirements or they may be set by the business owner in order to manage the availability of the provider.

FIG. 15: Illustrates the embodiment of the interface to feature the biographical information of the individual provider. System and method has the ability to scroll through and view other service providers.

FIG. 16: Illustrates the embodiment of the Graphic user interface used to by Groupon, Inc that demonstrates the existing method of presenting one than one deals. The second deal is a separate offer or a “side deal.”

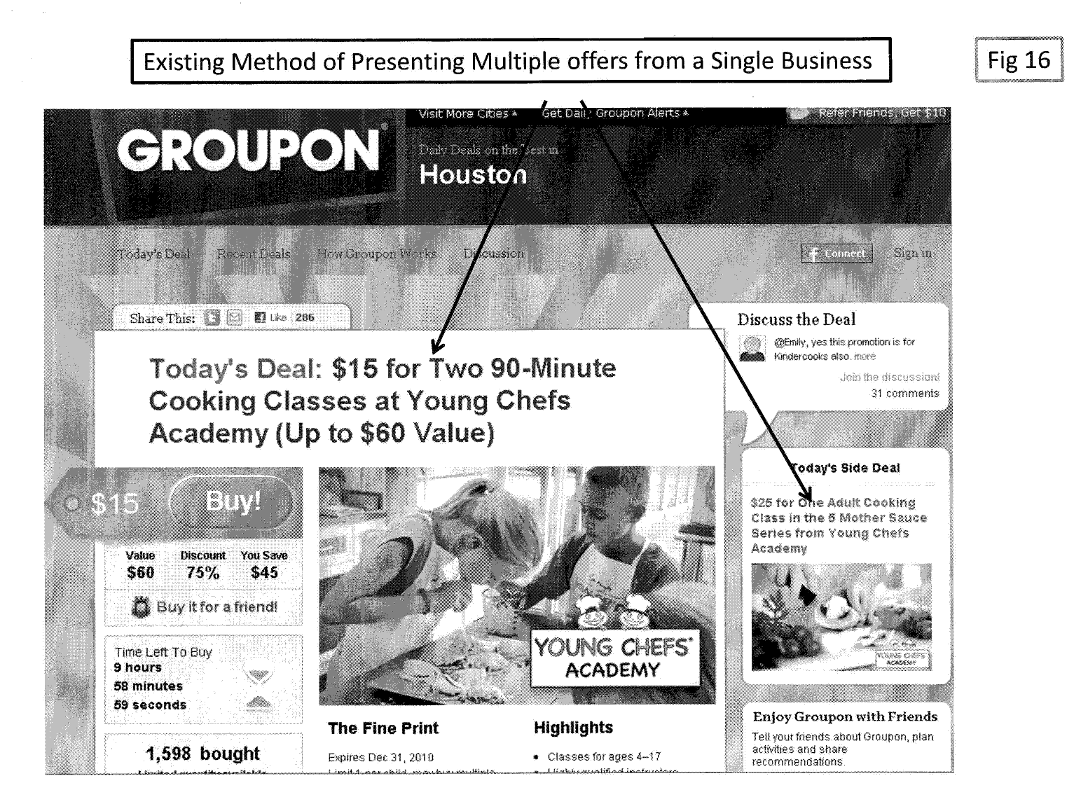

FIG. 17: Illustrates the embodiment of the Graphic user interface used to by Groupon, Inc. that demonstrates the name and location of business.

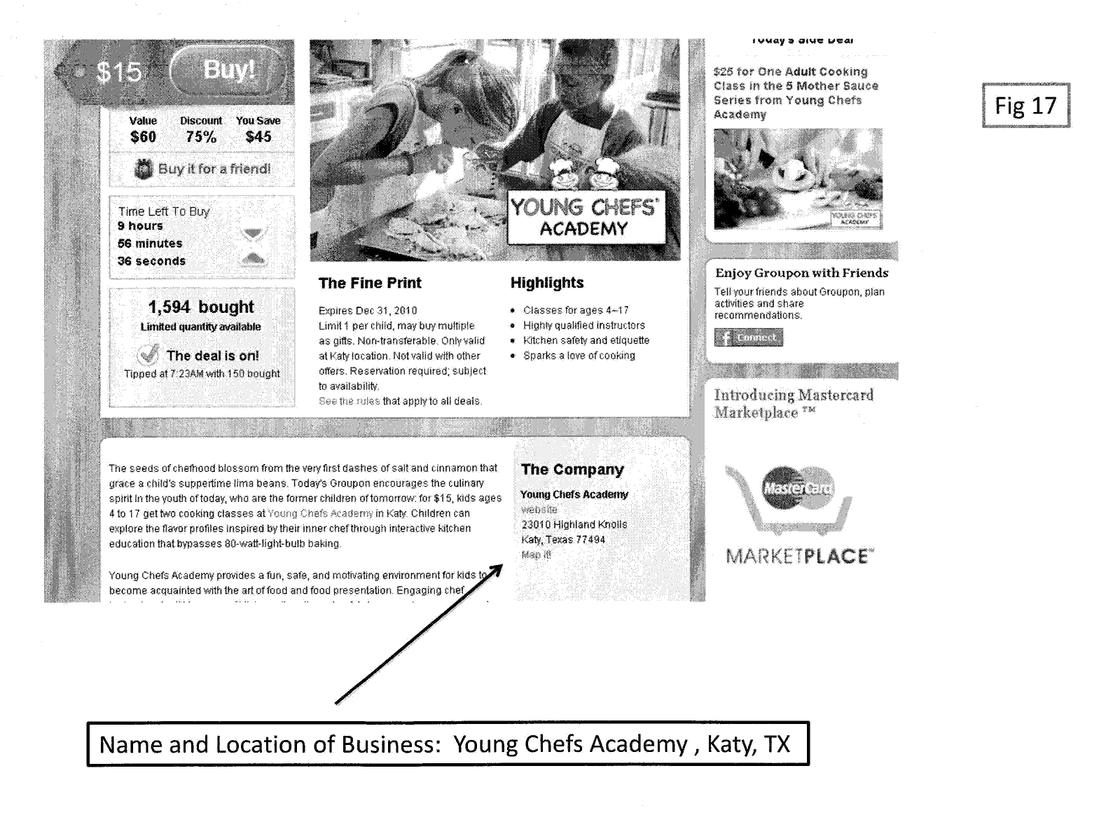

FIG. 18: Illustrates the embodiment of the Graphic user interface used to by Groupon, Inc. to demonstrate the name of business and location of business and provides evidence that the name of the business and location are the same for the secondary offer.

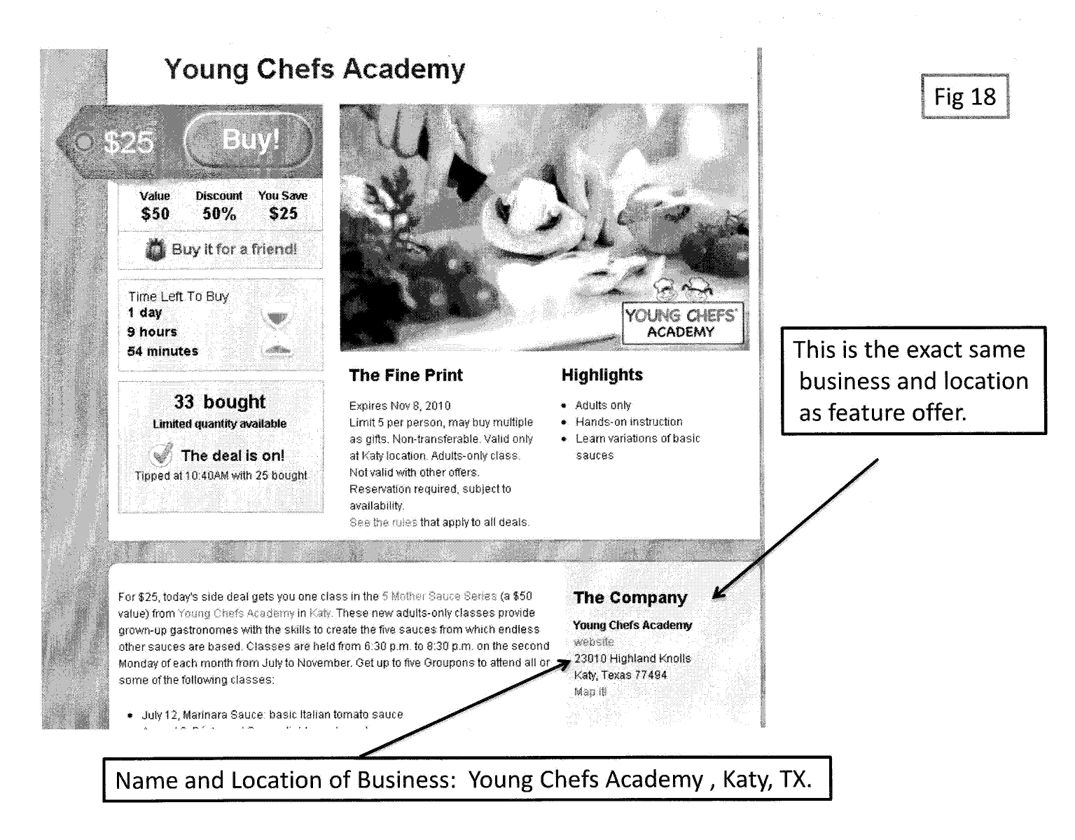

FIG. 19: Illustrates the system of the present invention as shown in FIGS. 1-15.

### DETAILED DESCRIPTION

The traditional shopping experience—buying goods at stores and malls (whether online or brick and mortar)—was designed by sellers with the primary purpose of promoting commerce for themselves. Not surprisingly, this prevalent sales model gives the seller virtually all of the power and control associated with a given sales transaction. This invention creates a new shopping experience by essentially reversing certain aspects of the traditional seller-oriented sales model. The result is a far more empowering shopping experience for the buyer.

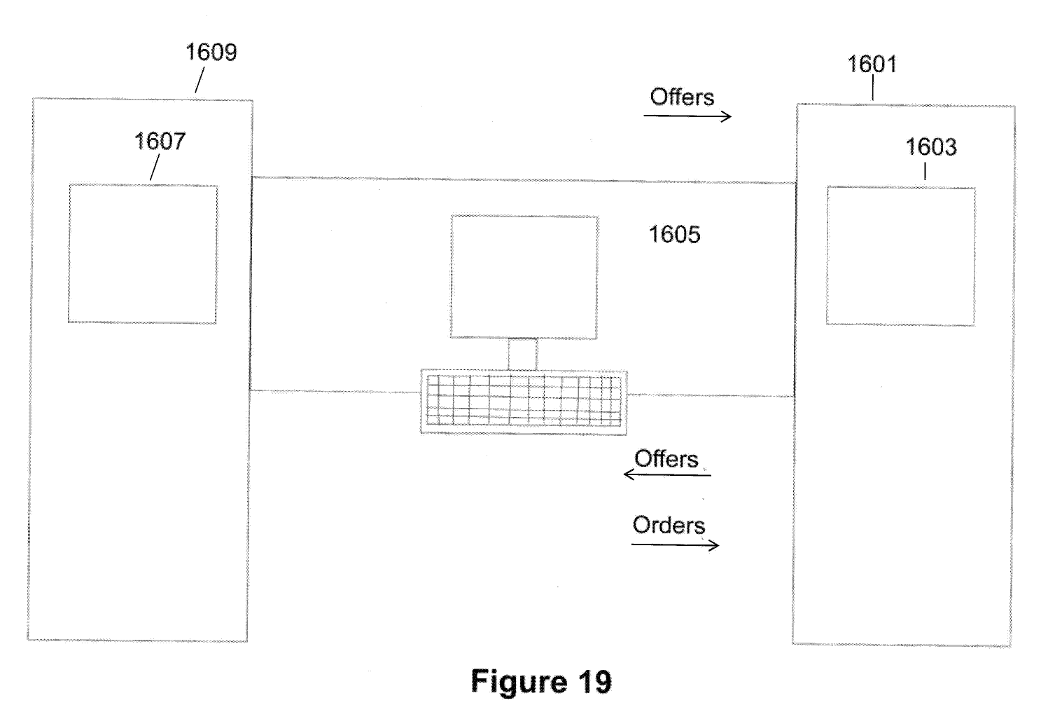

A system 1600 as shown in FIG. 19 for aggregating demand through an online buying group, which may include: (a) an e-commerce server-data processing system, the e-commerce server-data processing system including e-commerce server software 1603 executable on said e-commerce server-data processing system 1601 and configured to define a buying marketplace/display 1605 for a featured at least two different items by specifying the featured at least two different items for the marketplace, a time interval during which the marketplace is available, any minimum or maximum quantities of the featured at least two different items available through the marketplace, the marketplace defining a predetermined partial number of different items to activate the sale and one or more prices for the featured product available through the marketplace, said e-commerce server software 1603 further being configured to receive offers from buyers and to take orders for the featured items and said e-commerce server software also configured to notify a buyer who has made a successful offer that the offer has been accepted (b) a buyer client data processing system 1609 coupled to said e-commerce server-data processing system 1601, said buyer client data processing system 1609 including client software 1607 executable on said buyer client data processing system 1605 and configured to receive data from said e-commerce data processing system describing the conditions for buying the featured items, to display the data describing the conditions for the featured items on the buyer client data processing system, and to receive buyer order inputs that include the buyer's offer for the featured items and to transmit the buyer order inputs for the featured items to said e-commerce server-data processing system 1601.

The e-commerce server-data processing system may be configured to receive inputs for defining a buying marketplace 1605 for the featured items. The marketplace/display 1605 may be the interface 400, 500, 600, 700, 800, 900, 1000, 1100, 1200, 1300, 1400, 1500 and may be suitable to display from the server-data processing system 1600 or the e-commerce buyer client data system 1609.

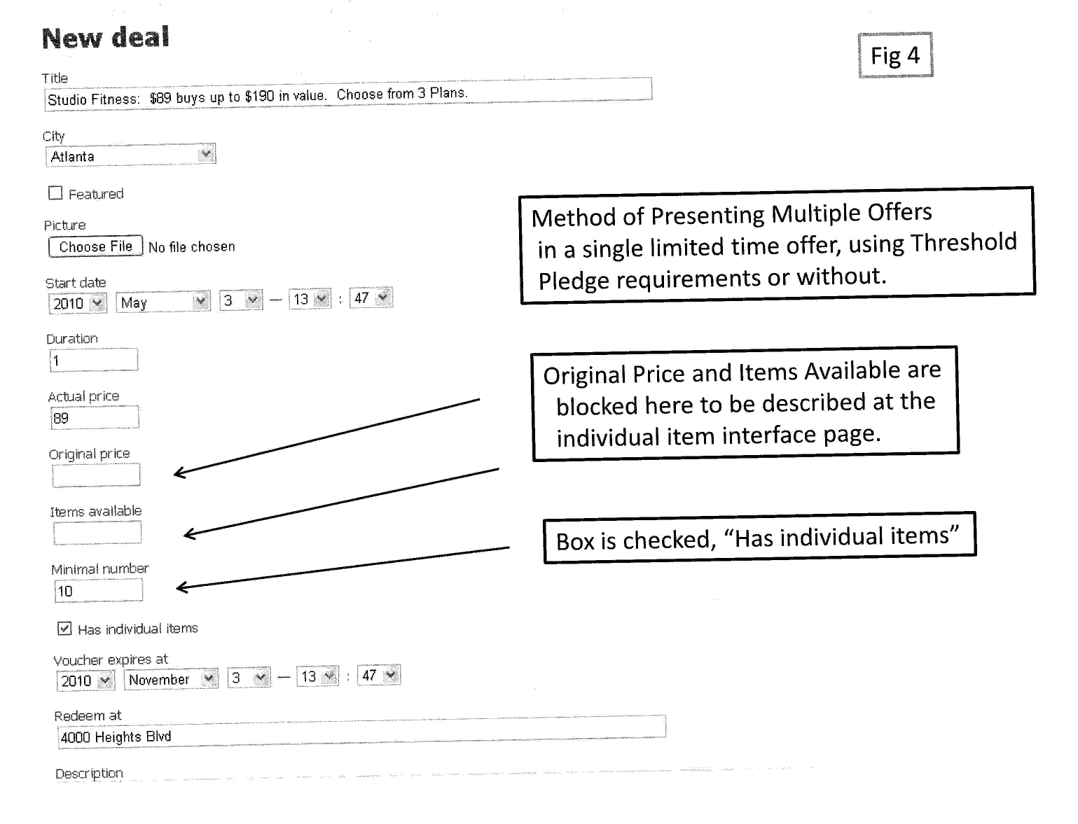

FIG. 4: Illustrates the embodiment of the display interface 400 of first entry page setup for “deals with individual items (products and services)”. System described here may utilize the Threshold Pledge requirements or choose no threshold requirement. “Original Price” and “Items (products and services) Available” input boxes are blocked here so that they may be described at the individual item interface page. A box described as “Has individual items (products and services)” is made available to “check” to trigger the ability to set up the interface for “Individual items (products and services).”

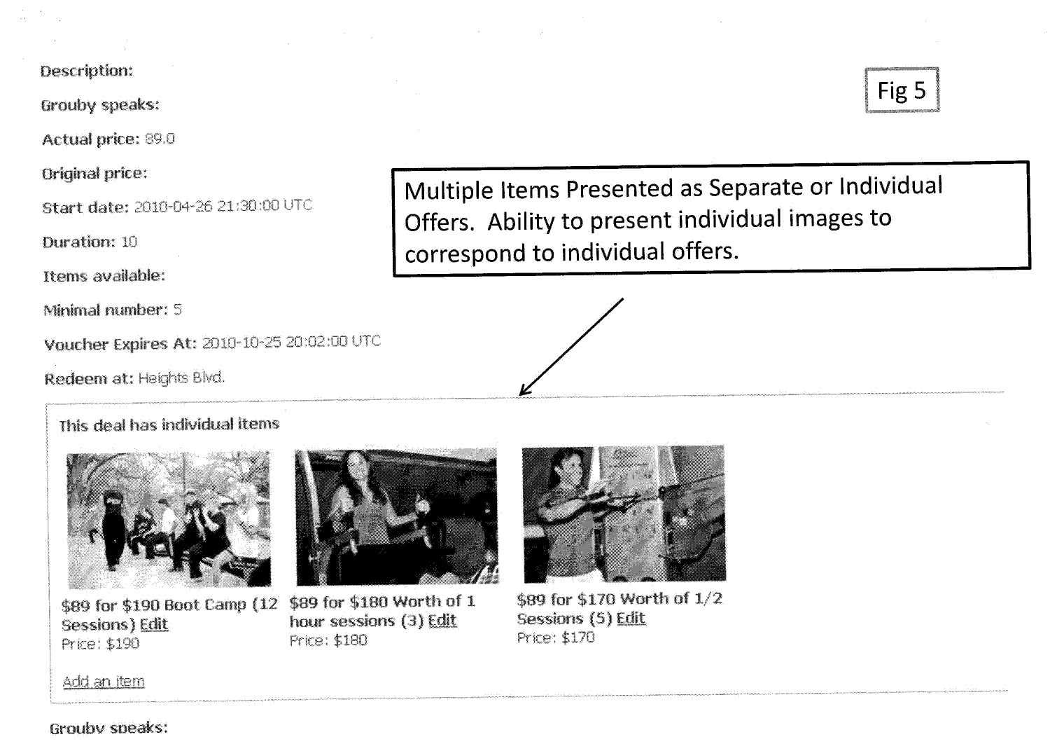

FIG. 5: Illustrates the embodiment of the display interface 500 to present multiple items (products and services) that are to be presented as separate or individual offers. This system has the ability to present individual images to correspond to individual offers.

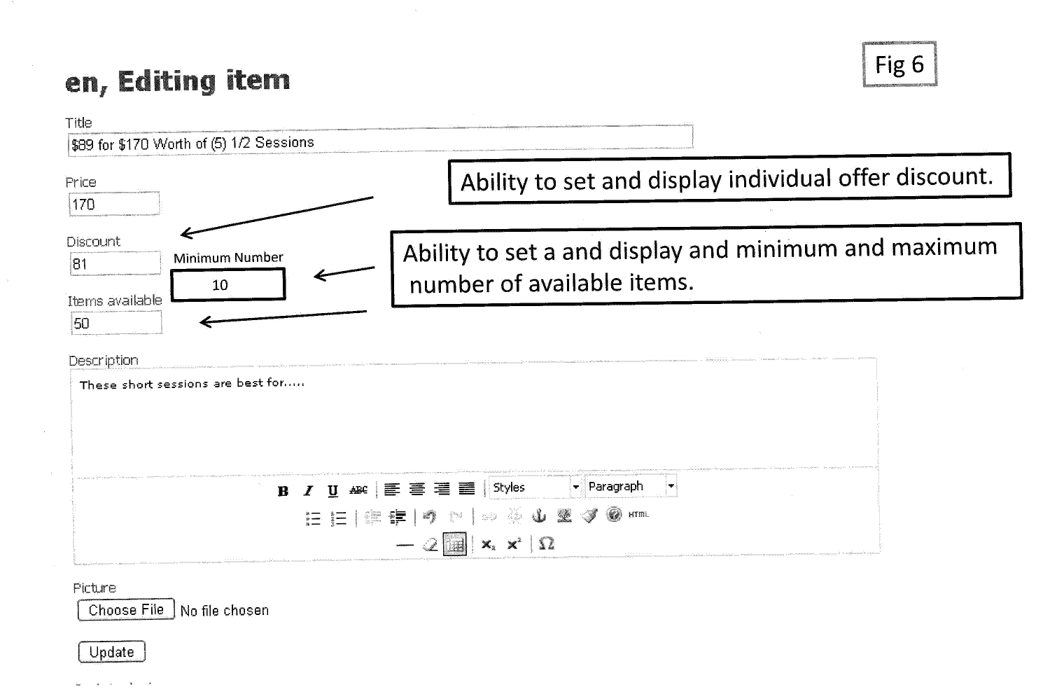

FIG. 6: Illustrates the embodiment of the display interface 600 to set specific discounts that pertain to an individual item. This system has the ability to describe and display a minimum number of items (products and services) that need to be agreed to buy in order to be valid (threshold pledge) and maximum number of available items (products and services) (limited quantity sell out).

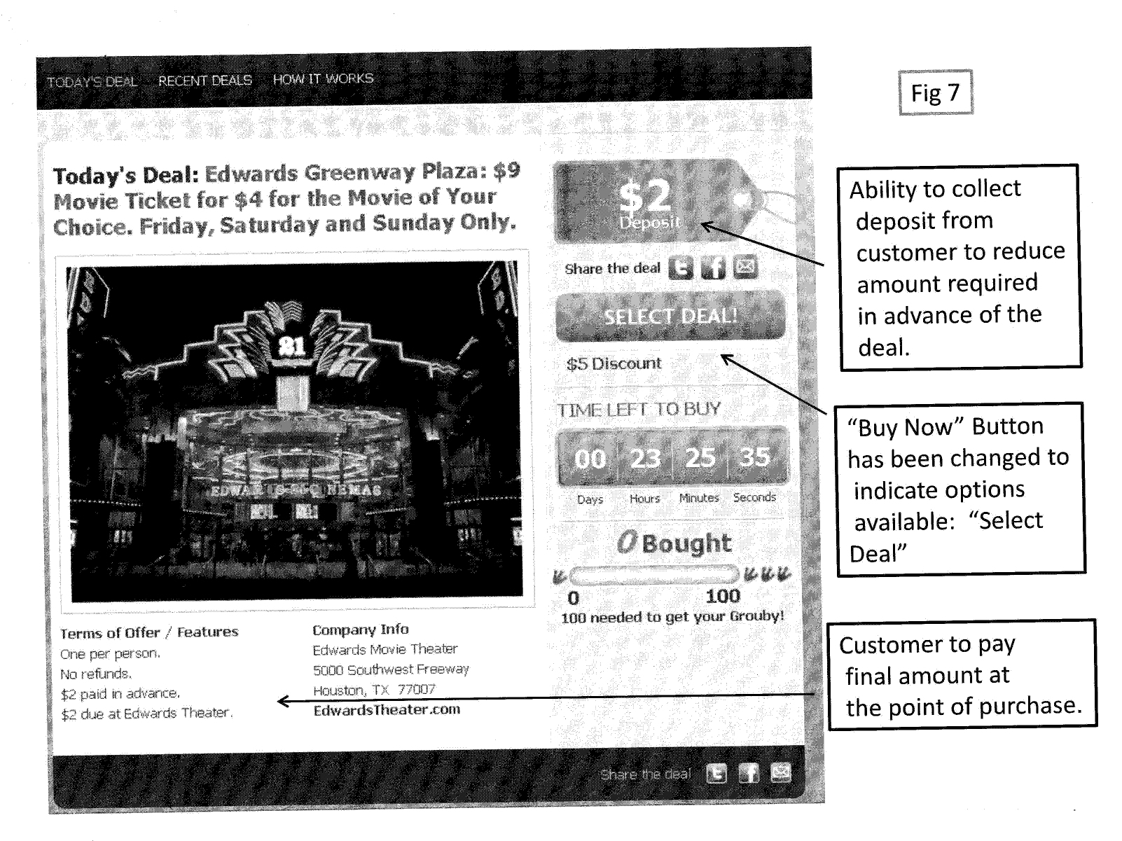

FIG. 7: Illustrates an Image and Graphic illustration 700 to demonstrate the ability of our system to collect a deposit from customer to reduce amount required in advance of the deal. Text description is shown to describe the ability for show the customer how much is left to pay at the point of purchase.

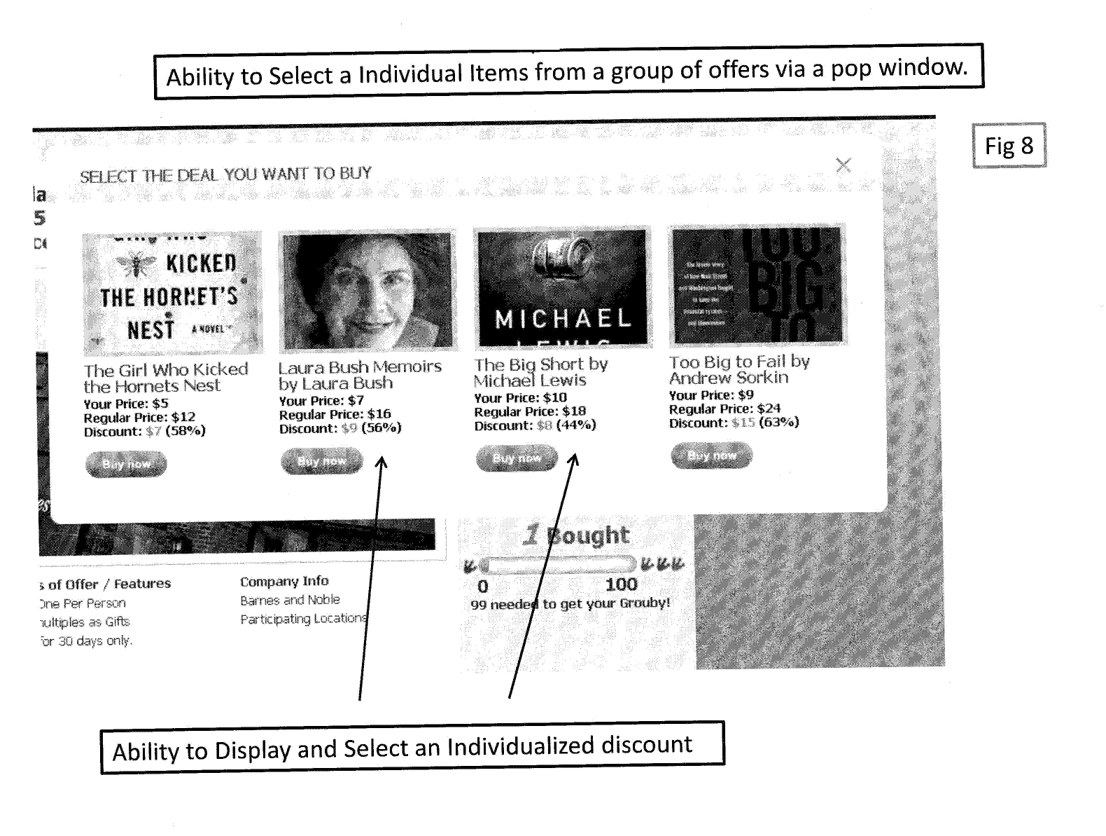

FIG. 8: Illustrates an Image and Graphic User Interface 800 to describe the ability to display Individual Items (products and services) as a group of offers via a pop window. Image and GUI displays describe an individual discount that corresponds to an individual offer.

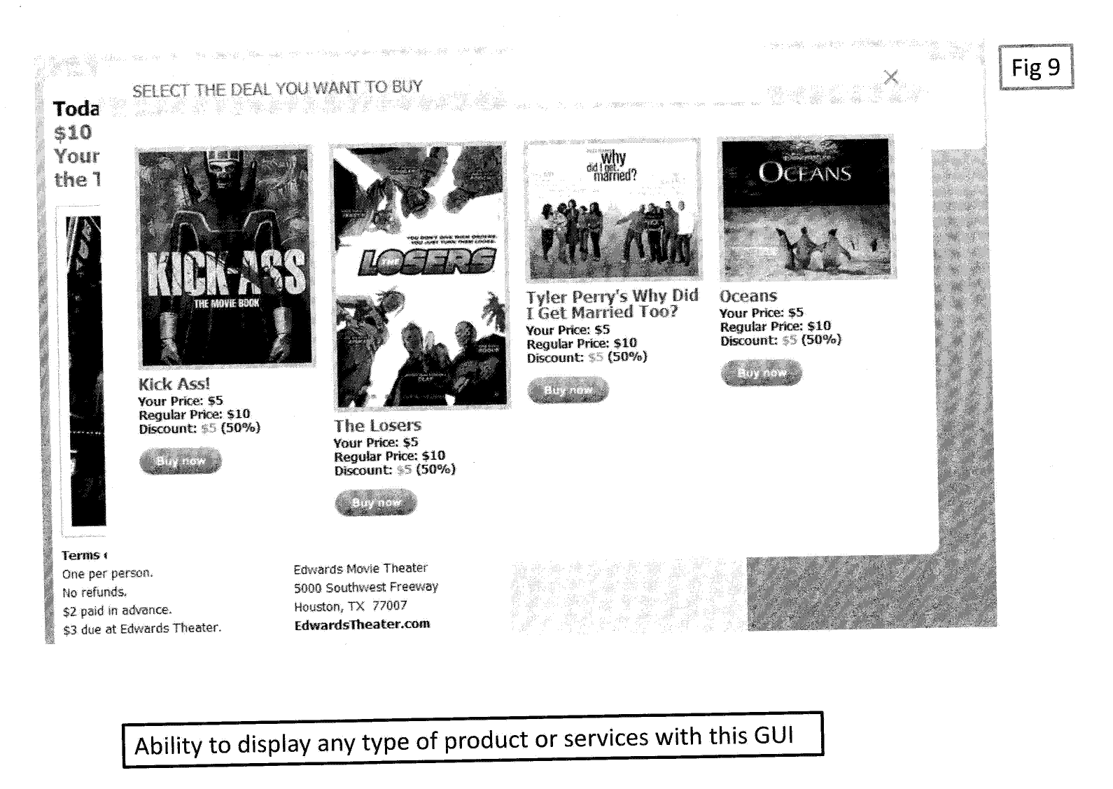

FIG. 9: Illustrates the embodiment of the Graphic User Interface 900 that allows our system to display any type of product or service and demonstrate the universal characteristics of this system and method.

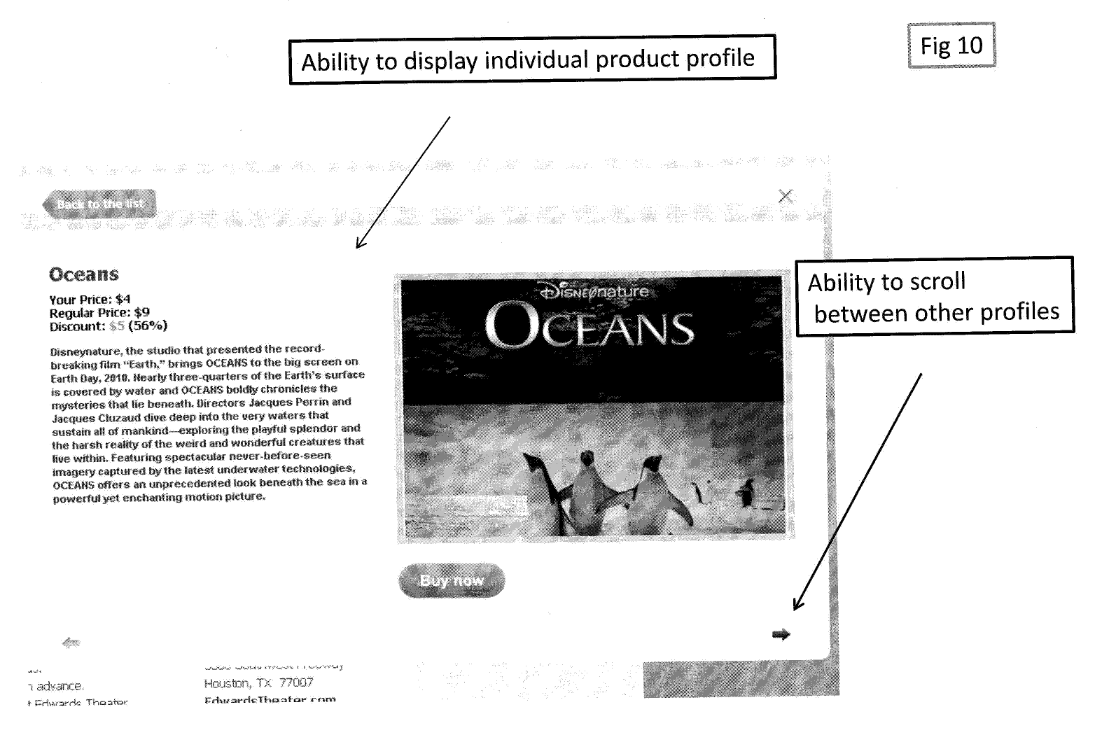

FIG. 10: Illustrates the embodiment of the Graphic User Interface 1000 that demonstrates the ability to display detailed information for individual item profiles and the ability to easily scroll to view other individual items (products and services) presented under the same limited time deal.

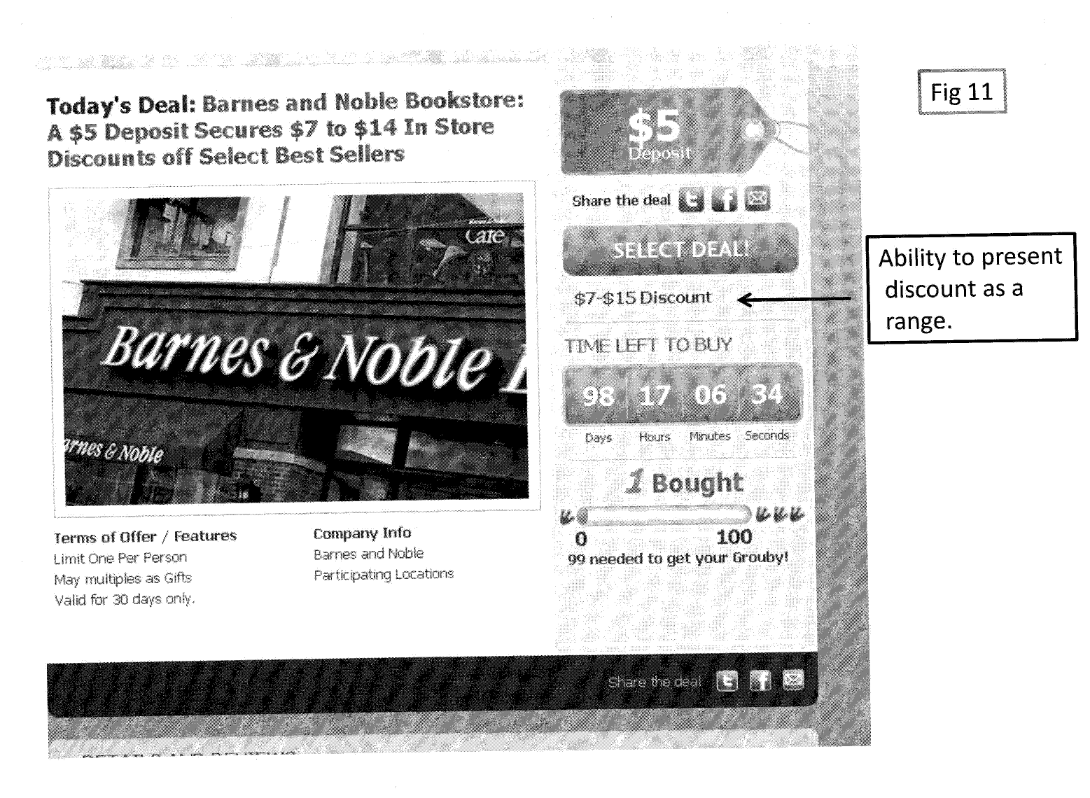

FIG. 11: Illustrates the embodiment of the Graphic User Interface 1100 that enables to the ability of our system and method to present the discount of individual offers as a range.

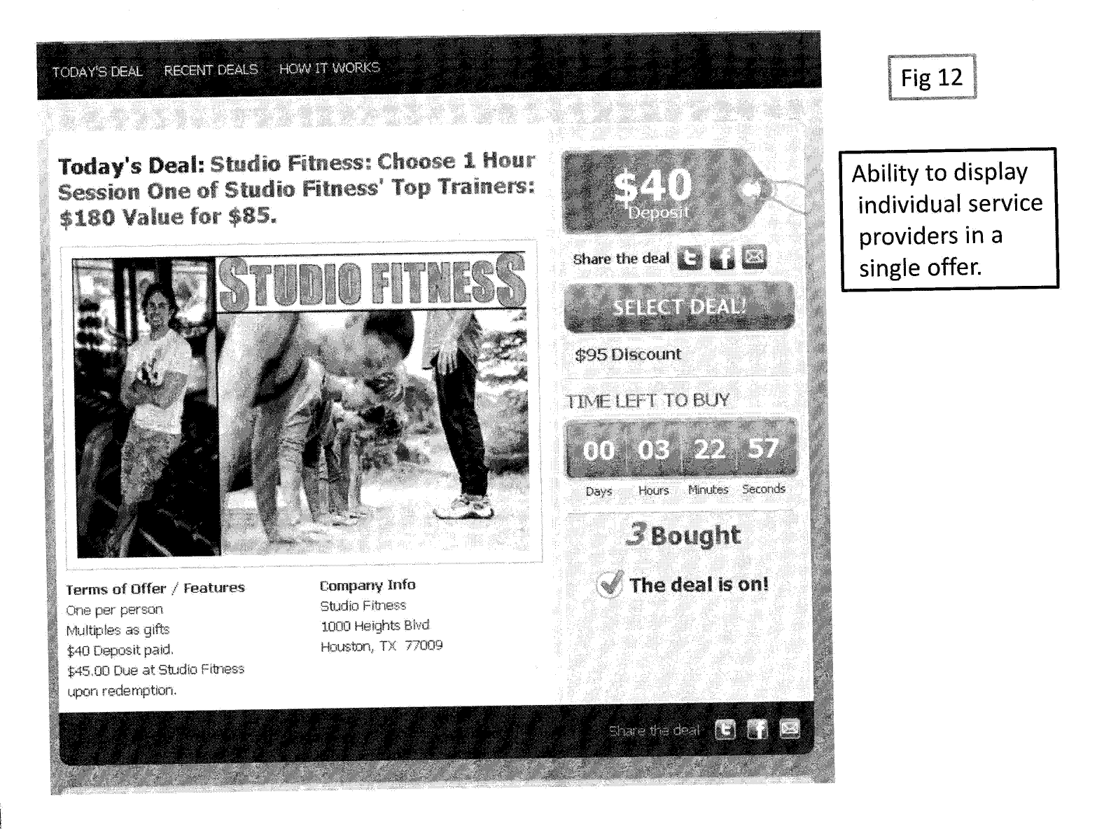

FIG. 12: Illustrates the embodiment of the Graphic User interface 1200 to display our method and system of presenting individual service providers within a single offer.

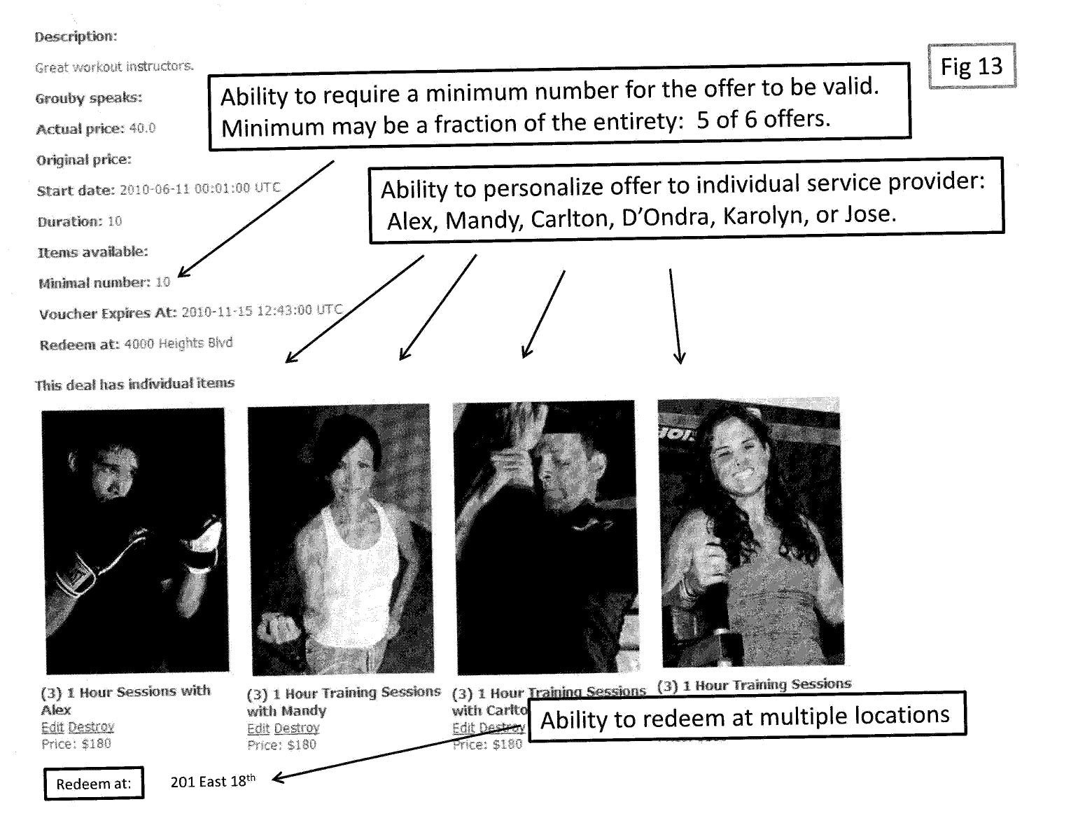

FIG. 13: Illustrates the embodiment of the interface 1300 that creates the ability to display the required minimum number for the offer to be valid. Our system and method allows that the minimum may be a fraction of the entirety. For example, 5 of 6 offers are described in FIG. 13. The system and method allow for the ability to personalize the offer by featuring individual service providers such as Alex, Mandy, Carlton, D'Ondra, Karolyn, or Jose. The system and method allows for the ability to redeem at multiple locations, which may be individualized to the individual service provider.

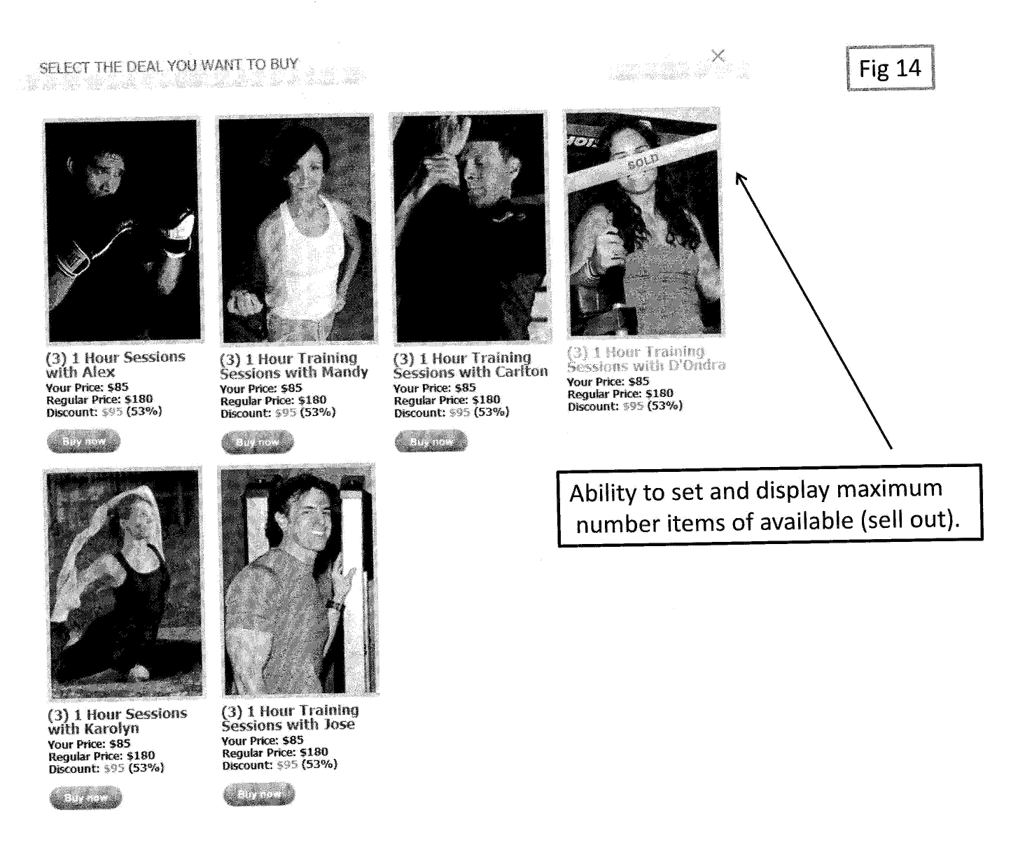

FIG. 14: Illustrates the embodiment of the display interface 1400 to set and display maximum number items (products and services) of available (sell out). Each individual provider may set their own requirements or they may be set by the business owner in order to manage the availability of the provider.

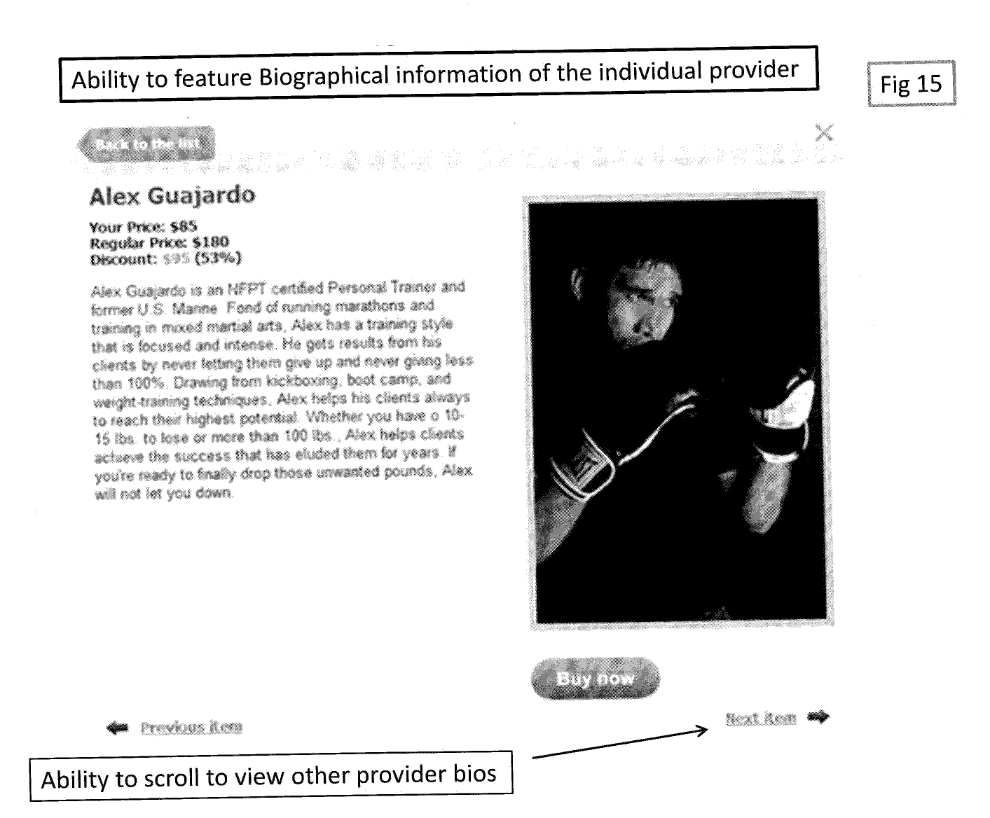

FIG. 15: Illustrates the embodiment of the display interface 1500 to feature the biographical information of the individual provider. System and method has the ability to scroll through and view other service providers.

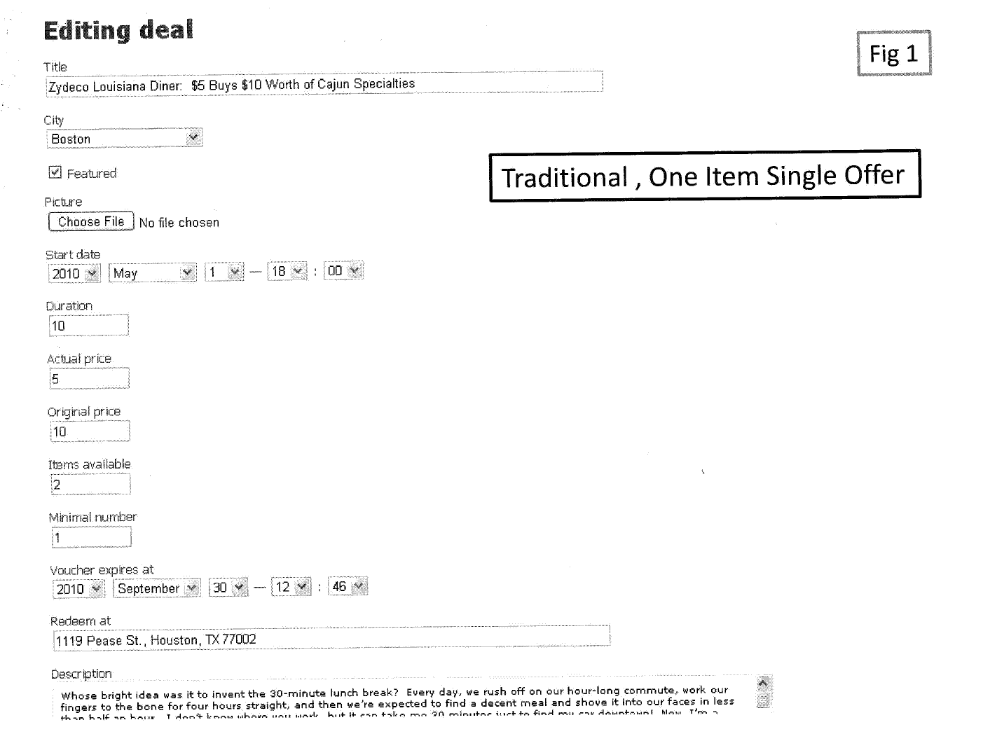

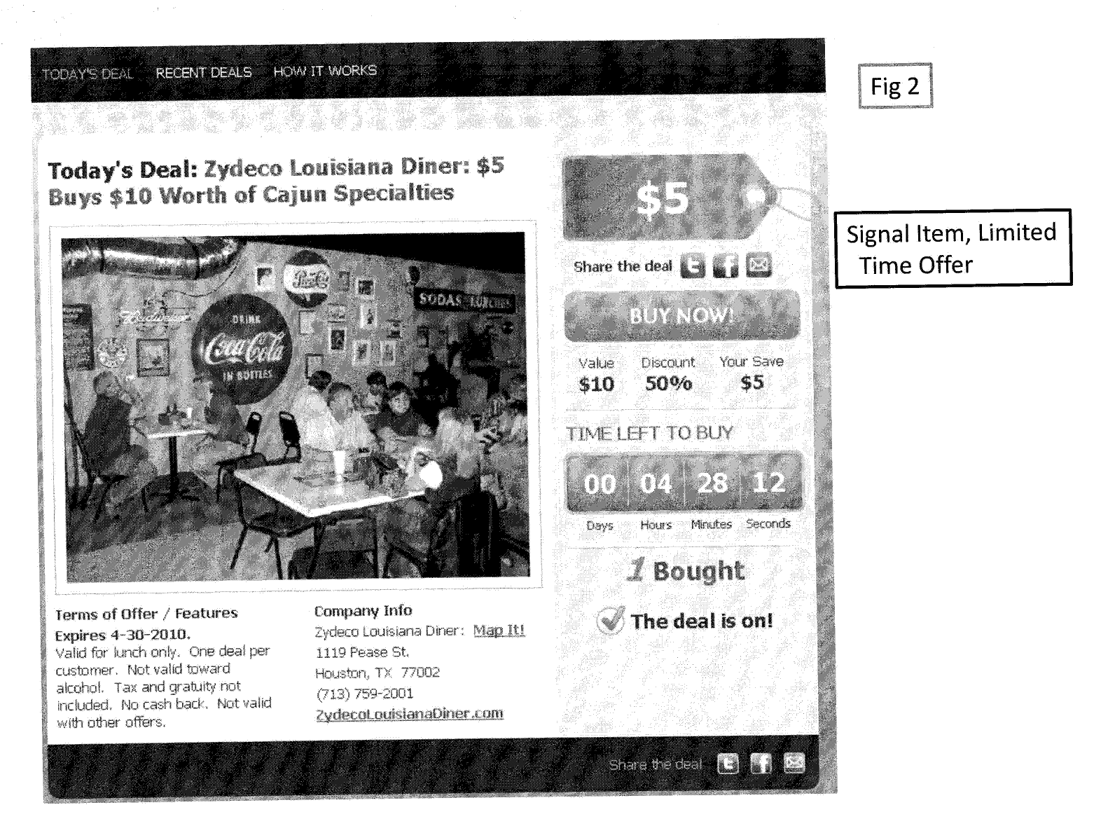

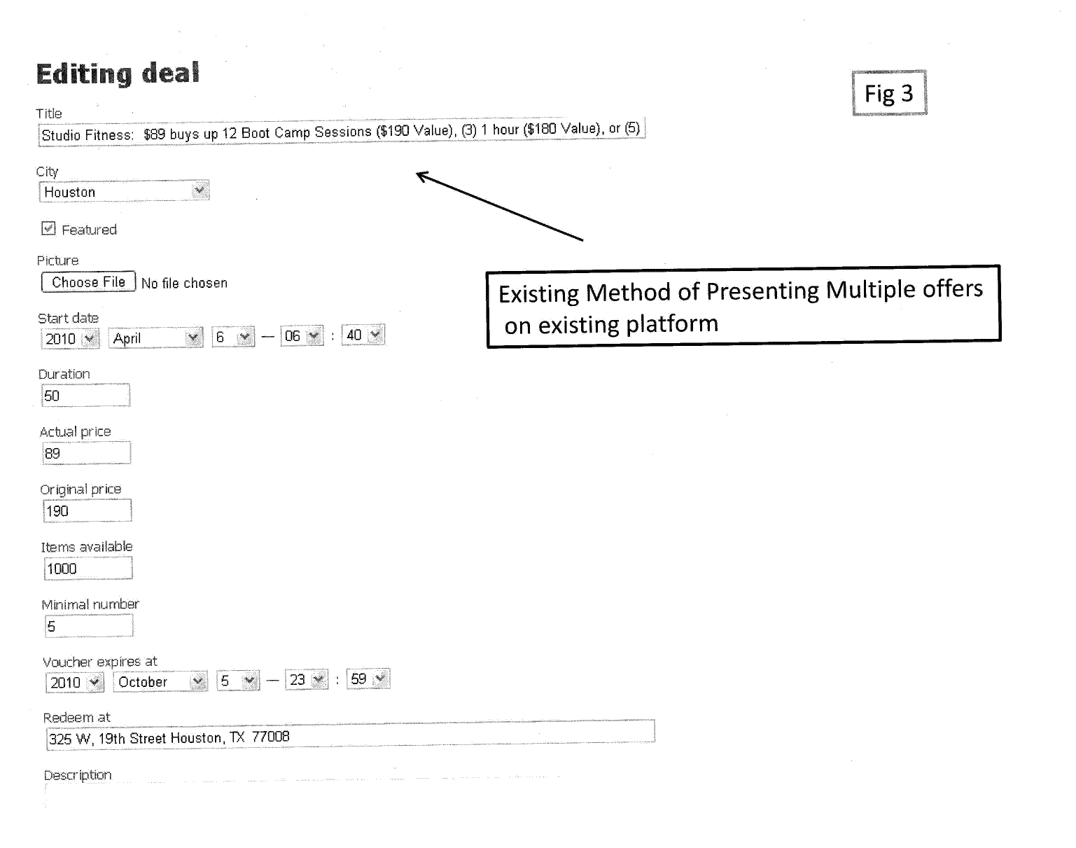

As shown in FIG. 1, a store 10 is simply a collection of products 12. As shown in FIG. 2, a mall 14, of course, is a collection of stores 10. Historically, buyers 16 have had to come to the seller's pre-selected and pre-priced collection of products 12 in order to make a purchase. This invention, represented in FIG. 3, turns the point of sale into a collection of buyers 16 operating in a marketplace including products 12. It further permits these co-ops to be located among any number of other co-ops at an Internet or other network site provided by a business entity implementing the invention. This fundamental shift in structure provides many advantages each discussed in detail below.

A system and method for facilitating media creation is disclosed that includes a marketplace module and facilitator that enable an artist to create a work or media and then distribute the work or media to the public, or a segment thereof. The marketplace module provides avenues for free speech, commentary, and constructive criticism, for example, of an artist's idea or work in order to encourage the creation of media which appeals to a minimum threshold of the public. The facilitator aggregates funds to satisfy an artist's commission by enabling negotiations between one or more members of the public and the artist.

This method and apparatus allow a seller to offer multiple goods or services which are different in terms of at least price or characteristics (while the upper limit may be unbounded there must be at least two different goods or services) that may be priced contingent upon the sale of a predetermined total amount or a predetermined fraction of total number or amount of items (products and services) offered. The buyer is offered the multiple goods or services at a discount or a reduced price in order to entice the buyer to enter into the transaction. One buyer does not necessarily have to commit to the predetermined total amount or the predetermined fraction of the total number or amount of items (products and services) offered. The offer may extend over a predetermined time in order to entice multiple buyers to enter into a transaction. Each buyer makes a commitment typically via supplying credit information over the internet to pay for the good or service offered and, should the predetermined total amount or the predetermined fraction be not reached within a predetermined period of time, the buyers who have made a commitment or are not charged at all or, if charged, entitled to a refund. The fraction or entire amount required to affect the sale may be set arbitrarily by the seller. The items (products and services) for sale may correspond to vouchers to be presented at the time of sale or rebates that are secured by deposits made to reserve a particular item. The items offered for sale may be either goods or services.

Our invention provides for more diverse offers from a single seller without reducing the odds of a sellout resulting from the dilution that occurs when a multitude of items (products and services) available are presented to a limited number of potential customers. Additionally, by allowing only a fraction of the entire offer to trigger the entire offer to be valid, poorly priced, undesirable and unwanted items (products and services) do not prohibit a deal to be effected with the majority of desirable items (products and services).

Due to the diversity of their product offerings and the cost structure variation that extends across their product lines, homebuilders, car dealers, electronics and big box retailers, and furniture dealers are examples of potential beneficiaries of this invention. Contract manufactures, meantime, that require minimum order amounts in order to do business are also positioned to benefit from the aggregation of individual purchases into a group and will also enjoy the flexibility and benefit of offering multiple products with discounts that may be particularized to the each of the items (products and services) offered.

Additionally, local businesses that have a multitude of products and services as well as independent, individual service providers may benefit from the method and apparatus of the present invention by offering limited time discounts that may be tied to the group outcomes or based on their own individual requirements. These requirements include their own individual minimum number of purchases that are required in order for an offer to be valid. This method of commerce is popularly known as a threshold pledge and has been used effectively to raise money over the Internet for social causes and single offers.

The prior art does not easily allow for the feature of complex offers, individual product SKUs, menu items (products and services), differential amounts, sizes, styles, or unique high-dollar items (products and services) such as houses, autos, or jewelry. Nor does prior art allow for the feature of independent service providers that may operate under the name of a particular business.

Our Method of Conducting Limited Time Offers for Non Identical Items (products and services) and Personal Services over the Internet overcomes the limitations posed by prior systems.

This approach will not only be more effective in producing productive offers of homes and automobiles but will allow for the combinatory sale of all types non-identical goods and services within group buying, selling and threshold-pledge framework. This approach will provide diversity in the offer and therefore greater relevance to customers. Additionally, this approach creates the possibility of creating diverse offers without diluting the strength of conventional daily deal limited time offer methodology. For example, instead of offering a single item from a specific service provider, several different items (products and services) may be offered creating more consumer choice and increasing relevance, while remaining tied to a single offer. If the total number of items (products and services) required, the total purchase price required, or a specific ratio (fraction) of items (products and services) offered is purchased, the threshold is met, triggering an actual purchase for everyone that has committed to buy.

The prior method requires dissimilar items (products and services) to be presented in the same offer or an entirely new offer, with an entirely new method of accounting to be created.

In the first case, the effective discount for the individual offer is rendered opaque. In the second instance, many buyers may overlook the additional deal. It remains obscured as a “side” offer that may appear to have little relation to the primary offer and is less effective as a result. (see description #16, 17, 18)

Along with discounts, customer choice as a general rule leads to customer satisfaction. In the context of our methodology, the present invention may offer both consumer choice and bulk-buy discounts.

An additional problem the invention addresses is the problem encountered when retailers desire to offer discounts, but wish to make the discount only on select items (products and services). Since products at big box retailers, hardware stores, and supermarkets are diverse and have large differential profit margins, the ability to offer select items (products and services) in bulk at a discount while creating threshold pledge requirements for each discount item in addition to simultaneously not requiring a sellout in order to trigger or activate a deal is crucial. The conventional limited time offer format conducted over the Internet adds to the success of the business intermediary but fails to offer their characteristic choice among a basket of goods.

The following are examples of the present invention:

The predetermined limit number of items (products and services) is the total inventory that the seller is willing to sell at the discount. This is an upper limit.

The predetermined total number of different items (products and services) available for the sale. This represents the number of items (products and services) which are differentiable.

The predetermined partial number of different items (products and services) which represents the minimum number of different items (products and services) which has to be sold.

The predetermined partial number of different items (products and services) to activate the sale. This represents the number of different items (products and services) (from the predetermined partial number of different items (products and services)) required to be sold to activate the sale.

The predetermined threshold value number is the total inventory value to be sold in order to activate the sale.

The predetermined time limit is the length of time for the above sales to occur within.

One of the predetermined partial number of different items (products and services) or the predetermined threshold number may be zero or both may be a non-zero number.
A luxury high-rise condo project offers its 40 remaining units for sale at a $50,000 discount. The developer requires that three quarters of the units (30) must receive commitments to buy from qualified buyers in order for the $50,000 discount to be activated. The discount for all of the buyers is only activated when (30) $1000 deposits are received on each individual property. The absolute limit number of items (products and services) in this example is 40.
The predetermined number of different items (products and services) is 40 because all of the units are unique. The predetermined partial number of different items (products and services) is 30 because all of the units are unique. The predetermined threshold number is 30.
A builder with 24 spec homes (many of which are priced differently) in a large suburban housing development agrees to a $20,000 discount on each home, provided commitments to buy are received on $4,000,000 worth of inventory at current prices (adjusted for the group discount. Here a fractional sellout is achieved, but this time it is dependent upon the price of the inventory chosen, and not by a predetermined ratio of commitments to inventory. The absolute limit number of items (products and services) is 24. The predetermined partial number of different items (products and services) is dependent not on the total number of units with commitments to buy but on the aggregate value of the individual units. The predetermined total number of different items (products and services) is 24 because all the units are unique. The predetermined threshold number is based on the value of inventory and not the number of units to be sold.
An electronics retailer offers a Sony Digital Camera, a 48 inch Samsung Flat Panel Television, a Gateway ultra-thin laptop, a Panasonic Digital Camcorder, and a Garmin portable GPS as a bundled offer at a 20% discount (the reduced price offer) from the offered price of each of these items (products and services), but only if four of the five items (products and services) offered sell 50 units or more with a sellout occurring at 100 units offered per item. In this example, the absolute limit number of items (products and services) is 100, and the predetermined total number of different items (products and services) is 6 different items (products and services). The predetermined partial number of different items (products and services) is 4, and the number of each of the predetermined partial members to activate the sale is 50.
A hardware retailer offers a 40% discount on ten different models of lawnmowers, provided they sell (4) or more lawnmowers of a minimum 7 of 10 of the ten items offered for sale. In order to activate the sale, a predetermined partial number of items (products and services) out of the total number of items (products and services) must have a commitment to buy a predetermined number of the total number of different items (products and services).
The absolute limit number of items (products and services) has not been set, and the predetermined partial number of different items (products and services) is seven. The predetermined total number of different items (products and services) is 10, and the predetermined partial number of different items (products and services) to activate the sale is twenty eight.
A Fitness Studio that wants to feature (3) different training packages while featuring (6) different personal trainers, allowing customers to choose individual packages or specific trainers based on their individual credentials or there aesthetic appeal (based on biographical information presented and photos). For buyers to achieve the discount, 10 persons must agree to purchase packages from any one of the (6) featured personal trainers. The predetermined limit number of items (products and services) has not been specified. The predetermined total number of different items (products and services) is 18 (the combination of three fitness programs from six trainers). The predetermined partial number of different items (products and services) is one, (one program from one trainer). The predetermined threshold value number is 10.
A Full Service Real Estate broker firm wants to feature (4) different agents offering 1% discount on commissions. For the offer to be valid, each individual agent must secure $100 deposits from five buyers of their discounted services with each individual agent offering customizable “extra” services: Gift Certificate at closing, free initial consultation, etc. the predetermined limit value of items (products and services) has not been set. The predetermined total number of different items (products and services) is 4, representing the four different agents, and the predetermined partial number of different items (products and services) is 4 because each agent must secure the sale. The predetermined threshold value number is five.
A restaurant desires to offer three individual specials for customers, fitting three distinct customer demographics: 1. $5 for $10 worth of food for single persons dining alone (one meal). 2. $15 for $35 worth of food for a couple or individual accompanied with a friend (two meals). 3. $35 for $70 offer for a family of four or more or a small group dining together (at least 4 meals). There is no predetermined limit number of items (products and services), and the predetermined total number of different items (products and services) is three (one meal, two meals, at least four meals). The predetermined partial number of different items (products and services) is one, and the predetermined partial number of different items (products and services) to activate the sale is one. There is no predetermined threshold value number.
(8) Independent attorneys are bundled into the same offer, discounting their similar services by a range of 50-90%. While these attorneys offer competitive services, they differ in location, education and experience. Each attorney may set his own threshold to determine if his discount is valid. (4) Attorneys of the (8) chose no volume threshold, while (2) require a minimum of 5 buyers, while the remaining (2) require 10 buyers for their discounted offer of services to be valid. The predetermined limit number of items (products and services) is zero and the predetermined total number of different items (products and services) is 8 (eight) and the predetermined partial number of different items (products and services) is one. The minimum number for an offer to be valid may vary according to the preference of the attorney.
A retail bookseller wishes to sell four bestsellers at discounts ranging from 48-65%. Each book is to be presented and discounted independently, with the requirement that at least (100) books are sold in total with a limit of (100) copies available for two of the books and (250) copies available for the other two books in the offer. The predetermined limit number of items (products and services) varies dependent on the item the predetermined limit number of items (products and services) for two books are 100 and the predetermined limit number of items (products and services) or the remaining two books are 250. The predetermined partial number of different items (products and services) is one, and the predetermined total number of different items (products and services) is four. The predetermined partial number of different items (products and services) to achieve the sale is 100. There is no predetermined threshold value.
A multiplex movie theater desires to sell discounted tickets to (8) different first run movies at their (24) theater location. All (8) movies are to be discounted by $5 dollars and with a limit of (100) seats available per show time. Show times available run from matinee to evenings, Monday to Friday. The predetermined limit number of items (products and services) is 100 per Showtime. The predetermined total number of different items (products and services) is 8 the number of movies times the number of locations.
(3) Offshore bicycle equipment contractors offer wholesale prices of manufactured goods to dealers and resellers around the world. Each manufacturer has a unique volume threshold required to trigger a valid sale. Each manufacturer offers an accelerating discount based on the number of items (products and services) purchased. Buyers may choose between contractors based on company information and user reviews supplied from the Internet.

### Current Method of Conducting a Threshold Pledge for Group Buying Over the Internet

Steps to this simple process may include:
1. An offer is presented with a title and description of the item.
2. The actual price is presented along with the original price.
3. Offer has a start and end date describing the duration of the deal.
4. A total number or near unlimited number of items (products and services) may be offered.
5. A minimum number of items (products and services) are described to trigger (or activate) the deal constituting what is referred to as the threshold pledge.
6. Offer is presented from the same seller with typically only one location.

This process is effective when presenting identical items (products and services). However, when presenting non-identical items (products and services) (such as watches, televisions, computers, appliances, etc.); multiple services or multiple service providers; variations in product size amount, style or brand of goods, a different approach is helpful and, in many cases, required.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A system for aggregating demand through an online buying group, which comprises:
(a) an e-commerce server-data processing system, said e-commerce server-data processing system including e-commerce server software executable on said e-commerce server-data processing system and configured to define a buying marketplace for a featured at least two different items by specifying the featured at least two different items for the marketplace, a time interval during which the marketplace is available, any minimum or maximum quantities of the featured at least two different items available through the marketplace, the marketplace defining a predetermined partial number of different items to activate a single sale and one or more prices for the featured product available through the marketplace, said e-commerce server software further being configured to receive offers from buyers and to take orders for the featured items and said e-commerce server software also configured to notify a buyer who has made a successful offer that the offer has been accepted; (b) a buyer client data processing system coupled to said e-commerce server-data processing system, said buyer client data processing system including first client software executable on said buyer client data processing system and configured to receive data from said e-commerce data processing system describing the conditions for buying the featured items, to display the data describing the conditions for the featured items on the buyer client data processing system, and to receive buyer order inputs that include the buyer's offer for the featured items and to transmit the buyer order inputs for the featured items to said e-commerce server-data processing system.

2. The system of claim 1 wherein the e-commerce server-data processing system configured to receive inputs for defining a buying marketplace for the featured items.

3. The system of claim 2 in which said e-commerce server-data processing system includes a pricing tool to establish a price for each of the featured items in the marketplace.

4. The system of claim 3 wherein the e-commerce server-data processing system is further configured by including data entry tools to establish a start time and an end time for the marketplace.

5. The system of claim 3 wherein the e-commerce server-data processing system is further configured by including data entry tools to establish minimum or maximum quantities.

6. The system of claim 5 in which said e-commerce server-data processing system is configured to receive a buyer order input in terms of an offer to purchase the featured items.

7. The system of claim 6 in which said e-commerce software is further configured to accept the offer that is triggered when a specific numbers of commitments are received.

8. The system for an online buying co-op of claim 5 in which said e-commerce server-data processing system is further configured to receive credit card numbers from buyers to guarantee received commitments are triggered when a pre-determined number of commitments have been received.

9. The system of claim 1 in which said e-commerce server software is further configured to close the buyer marketplace when either the time interval for the co-op has expired, or the maximum quantity of the featured product has been allocated to irrevocable purchase offers.

10. The system of claim 3 wherein the e-commerce server-data processing system is further configured by including data entry tools to calculate a final sales price for the featured product based on acceptable offers received and the quantity of the featured product that has been committed.

11. The system of claim 3 wherein the e-commerce server-data processing system is further configured by including data entry tools to provide order fulfillment instructions for offers that have been accepted.

12. A system for aggregating demand through an online buying group, which comprises: (a) an e-commerce server-data processing system, said e-commerce server-data processing system including e-commerce server software executable on said e-commerce server-data processing system and configured to define a buying marketplace for a featured at least two different products by specifying the featured at least two different items for the marketplace, a time interval during which the marketplace is available, any minimum or maximum quantities of the featured at least two different product available through the marketplace, the marketplace defining a predetermined partial number of different items, a predetermined threshold value number of the predetermined partial number of different items to activate the sale and one or more prices for the featured product available through the marketplace, said e-commerce server software further being configured to receive offers from buyers and to take orders for the featured items and said e-commerce server software also configured to notify a buyer who has made an successful offer that the offer has been accepted (b) a buyer client data processing system coupled to said e-commerce server-data processing system, said buyer client data processing system including first client software executable on said buyer client data processing system and configured to receive data from said e-commerce data processing system describing the conditions for buying the featured product, to display the data describing the conditions for the featured items on the buyer client data processing system, and to receive buyer order inputs that include the buyer's offer for the featured product and to transmit the buyer order inputs for the featured product to said e-commerce server-data processing system.

13. The system of claim 3 wherein the e-commerce server-data processing system is further configured by including data entry tools to notify successful buyers that their offers have been accepted.
